(19) United States
(12) Patent Application Publication
(10) Pub. No.: US 2023/0020953 A1
(43) Pub. Date: Jan. 19, 2023

(54) Processing Apparatus, Program, And Method

(71) Applicant: GungHo Online Entertainment, Inc., Tokyo (JP)

(72) Inventor: Daisuke YAMAMOTO, Tokyo (JP)

(21) Appl. No.: 17/882,712

(22) Filed: Aug. 8, 2022

Related U.S. Application Data
(63) Continuation of application No. PCT/JP2021/025509, filed on Jul. 6, 2021.

(51) Int. Cl. A63F 13/48

(52) U.S. Cl. CPC A63F 13/48

(57) ABSTRACT

A processing apparatus includes a memory and a processor. The memory is configured to store determination information of whether a first user is allowed to execute a virtual game including at least a first game period in which a first unit game is executable and a second game period in which a second unit game is executable. The processor is configured to allow, in a case where the first user selects execution of the first unit game in the first game period, the execution of the first unit game regardless of the determination information and determine, in a case where one user selects execution of the second unit game in a period before the second game period, whether the execution of the second unit game is allowed based on the determination information.

### CROSS-REFERENCE TO RELATED APPLICATIONS

The present application is a continuation application of International Application No. PCT/JP2021/025509, filed on Jul. 6, 2021, which is expressly incorporated herein by reference in its entirety.

### BACKGROUND

### 1. Technical Field

The present disclosure relates to a processing apparatus, a program, and a method that cause progress of a virtual game that enables execution of a unit game in a previously determined period.

### 2. Related Art

Conventionally, known has been a season-based virtual game in which, with a predetermined period previously determined as one season, each user executes a unit game in the season to compete for the result of the unit game. For example, Japanese Patent Publication No. 2018-191723 A discloses a system in which, with a plurality of days previously determined as one season, competition is achieved for ranking or popularity, on the basis of the result of a drive racing game executed in the season.

### SUMMARY

In consideration of such techniques as above, an object of the present disclosure is to provide a processing apparatus, a program, and a method that enable provision of a more interesting season-based virtual game to a user.

According to one aspect of the present disclosure, provided is “a processing apparatus including: a memory configured to store, in addition to a predetermined instruction command, determination information for determination of whether or not a first user who causes progress of a virtual game including at least a first game period in which a first unit game is executable and a second game period that is set following the first game period and enables a second unit game to be executed, is to be allowed to execute the virtual game; and a processor configured to perform control, based on the predetermined instruction command, such that in a case where the first user selects execution of the first unit game in the first game period, the execution of the first unit game is allowed regardless of the determination information, and in a case where the first user selects execution of the second unit game in a period before the second game period, the execution of the second unit game is allowed based on the determination information”.

According to one aspect of the present disclosure, provided is “a program for causing a computer including a memory configured to store determination information for determination of whether or not a first user who causes progress of a virtual game including at least a first game period in which a first unit game is executable and a second game period that is set following the first game period and enables a second unit game to be executed, is to be allowed to execute the virtual game, to function as a processor configured to allow, in a case where the first user selects execution of the first unit game in the first game period, the execution of the first unit game, regardless of the determination information, the processor being configured to allow, in a case where the first user selects execution of the second unit game in a period before the second game period, the execution of the second unit game, based on the determination information”.

According to one aspect of the present disclosure, provided is “a method to be performed, in a computer including a memory configured to store, in addition to a predetermined instruction command, determination information for determination of whether or not a first user who causes progress of a virtual game including at least a first game period in which a first unit game is executable and a second game period that is set following the first game period and enables a second unit game to be executed, is to be allowed to execute the virtual game, due to execution of the predetermined instruction command by a processor, the method comprising: allowing, in a case where the first user selects execution of the first unit game in the first game period, the execution of the first unit game, regardless of the determination information; and allowing, in a case where the first user selects execution of the second unit game in a period before the second game period, the execution of the second unit game, based on the determination information”.

According to an embodiment of the present disclosure, provided can be a processing apparatus, a program, and a method that enable provision of a more interesting season-based virtual game to a user.

Note that the effect is just exemplary for convenience of description and thus is not limiting. In addition to the effect or instead of the effect, any effect in the present disclosure or any effect obvious to a person skilled in the art can be achieved.

### BRIEF DESCRIPTION OF THE DRAWINGS

FIG. 1 is a diagram conceptually illustrating progress of a virtual game according to an embodiment of the present disclosure.

FIG. 2 is a conceptual diagram of a schematic configuration of a system 1 according to the embodiment of the present disclosure.

FIG. 3 is a block diagram of an exemplary configuration of a server apparatus 200 according to the embodiment of the present disclosure.

FIG. 4A is a diagram conceptually illustrating a user table stored in the server apparatus 200 according to the embodiment of the present disclosure. Further, FIG. 4B is a diagram conceptually illustrating a season table stored in the server apparatus 200 according to the embodiment of the present disclosure.

FIG. 5 illustrates a processing sequence to be performed between a terminal apparatus 100 and the server apparatus 200 according to the embodiment of the present disclosure.

FIG. 6 illustrates a processing flow to be performed in the server apparatus 200 according to the embodiment of the present disclosure.

FIG. 7 is a diagram conceptually illustrating progress of the virtual game according to the embodiment of the present disclosure.

FIG. 8 illustrates a processing flow to be performed in the server apparatus 200 according to the embodiment of the present disclosure.

FIG. 9 illustrates a processing flow to be performed in the server apparatus 200 according to the embodiment of the present disclosure.

FIG. 10 illustrates a processing flow to be performed in the server apparatus 200 according to the embodiment of the present disclosure.

FIG. 11A illustrates an exemplary image output on the terminal apparatus 100 according to the embodiment of the present disclosure. Further, FIG. 11B illustrates an exemplary image output on the terminal apparatus 100 according to the embodiment of the present disclosure.

FIG. 12 illustrates an exemplary image output on the terminal apparatus 100 according to the embodiment of the present disclosure.

FIG. 13 is a block diagram of an exemplary configuration of the terminal apparatus 100 according to the embodiment of the present disclosure.

FIG. 14 illustrates a processing sequence to be performed between the terminal apparatus 100 and the server apparatus 200 according to the embodiment of the present disclosure.

FIG. 15 a diagram conceptually illustrating progress of the virtual game according to the embodiment of the present disclosure.

### DESCRIPTION OF EXEMPLARY EMBODIMENTS

An embodiment of the present disclosure will be described with reference to the accompanying drawings. Note that the same constituent elements in the drawings are denoted with the same reference signs.

### 1. Outline of Application according to Present Disclosure

A virtual game according to the embodiment of the present disclosure is executed as a game application, for example, in a terminal apparatus. Then, at least one user participates as a participant in the virtual game, so that the at least one participant user can control the progress thereof. The virtual game is season-based, in which a predetermined game period is set as one season and termination of the game period causes a new season to start.

Typical examples of such a virtual game include fighting games, sports games, racing games, puzzle games, combat games, and role-playing games. A system according to the present disclosure can be suitably applied to any of the various virtual games.

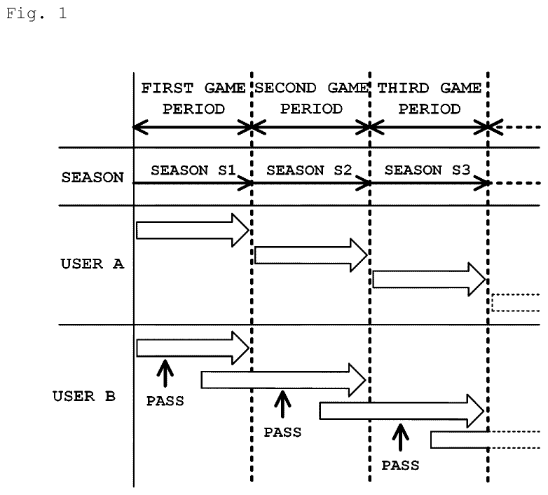

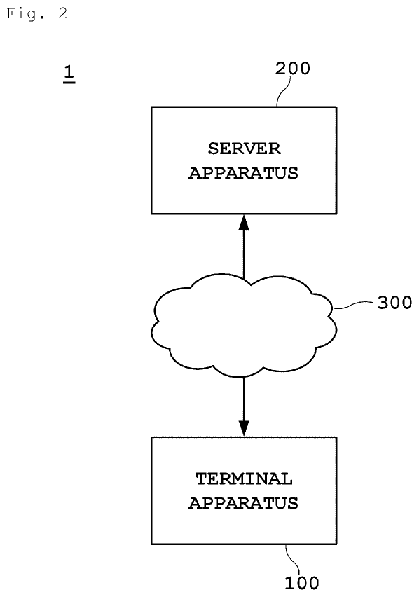

FIG. 1 conceptually illustrates progress of the virtual game according to the embodiment of the present disclosure. Referring to FIG. 1, for example, set are a first game period having a predetermined number of days (e.g., three months), a second game period having a predetermined number of days (e.g., four months) that starts following the first game period, and a third game period having a predetermined number of days (e.g., two months) that starts following the second game period. Then, with each game period as one season, a season S1, a season S2, and a season S3 are set.

Each user can execute at least one unit game in each season. Each user can accumulate results of execution thereof in the same season, to compete, for example, against the other users for the accumulated result. In response to termination of one season, the corresponding result is reset. In response to termination of one season, a new season starts in the next game period. Then, the users each can accumulate results of execution of a unit game in the season, to compete, for example, against the other users for the accumulated result.

For example, referring to FIG. 1, a user A can execute a first unit game a plurality of times in the season S1 set to the first game period. When the next second game period starts following termination of the first game period, the user A can execute a second unit game a plurality of times in the season S2 set to the second game period. Furthermore, when the next third game period starts following termination of the second game period, the user A can execute a third unit game a plurality of times in the season S3 set to the third game period. That is, the user A can execute the first unit game only in the first game period, the second unit game only in the second game period, and the third unit game only in the third game period, and thus is not allowed to execute the second unit game and the third unit game in the first game period and the third unit game in the second game period.

On the other hand, a user B possesses particular item information called a “pass” in advance before the next game period. Thus, the user B can execute, ahead of the user A, the second unit game executable only in the second game period during the first game period and the third unit game executable only in the third game period during the second game period.

As above, only a particular user having the pass is allowed to execute the unit game that is originally executable only in a predetermined period, before the period. Thus, for example, before the period, the particular user shares the reputation of the unit game with other general users, so that the general users can be made interested in the unit game before the period. As an example, the operator of the virtual game grants the pass for the second unit game executable in the second game period, to a user called an influencer. Then, sharing the reputation of the second unit game with general users who are a large number of followers of the influencer before the second game period enables an effect of advertising on the general users.

Note that, in the present disclosure, regarding each game period, when a game period starts, for example, the termination time of the game period or the start time of the next game period has not necessarily been determined. For example, after each game period starts, the termination time thereof or the start time of the next game period may be determined.

In the present disclosure, each game period is not necessarily set regularly. For example, respective different periods may be set for the seasons such as the season S1 corresponds to three months, the season S2 corresponds to four months, and the season S3 corresponds to three months. The next game period does not necessarily start immediately after the previous game period terminates. For example, the next game period may start after a certain period following termination of the previous game period.

In the present disclosure, each game period may be set in units of hours, days, months, or years. Note that, in a case where each user improves its proficiency level in the virtual game and competes for accumulation of results acquired due to execution of a unit game, a game period of at least several days or more is preferably set.

In the present disclosure, the range from start to termination of each game period is called a season. However, the term “season” is just a name expressing the corresponding period. Needless to say, a different name, such as an event or series, may be provided.

In the present disclosure, a unit game that is part of the virtual game just means a game aggregate to be executed, such as at least one quest, at least one scenario, at least one chapter, at least one dungeon, at least one mission, at least one combat, at least one fight, at least one battle, or at least one stage. Exemplarily, a unit game means one game in a baseball game or football game or one battle in a fighting game, or means a plurality of battles to be repeatedly performed in the same battlefield, virtual game space, or virtual environment, in a season. In one season or one game period, only one unit game may be executable or a plurality of unit games may be executable.

In the present disclosure, whether the unit game that is originally executable in the next game period should be allowed to be executed before the game period is determined on the basis of the presence or absence of the “pass”. Such a pass is granted to each user, for example, on the basis of the proficiency level in the virtual game, the attainment level in the virtual game, the number of follower users or friend users for each user, permission of the operator of the virtual game, or any combination thereof. Note that the pass is a type of so-called item information and may be provided in any form, such as a virtual item having a particular shape, an item that a user can retain personally (e.g., a card-type item, the card being given a two-dimensional code including information regarding allowance, the two-dimensional code being to be read by a terminal apparatus), or information itself indicating that execution is allowed before the game period.

In the present disclosure, a processing apparatus includes a terminal apparatus and a server apparatus. That is, the terminal apparatus and the server apparatus can each perform each piece of processing according to the embodiment below.

### 2. Configuration of System 1

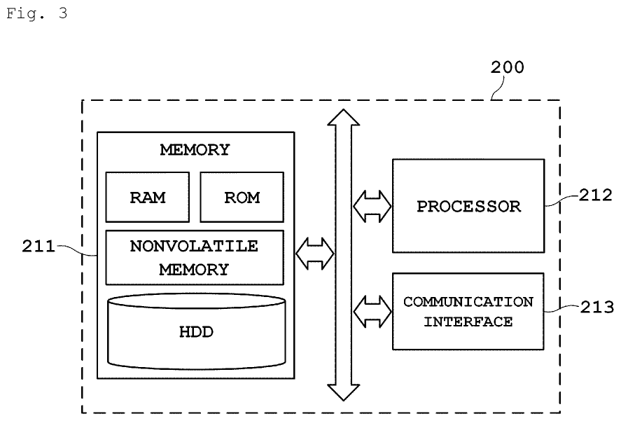

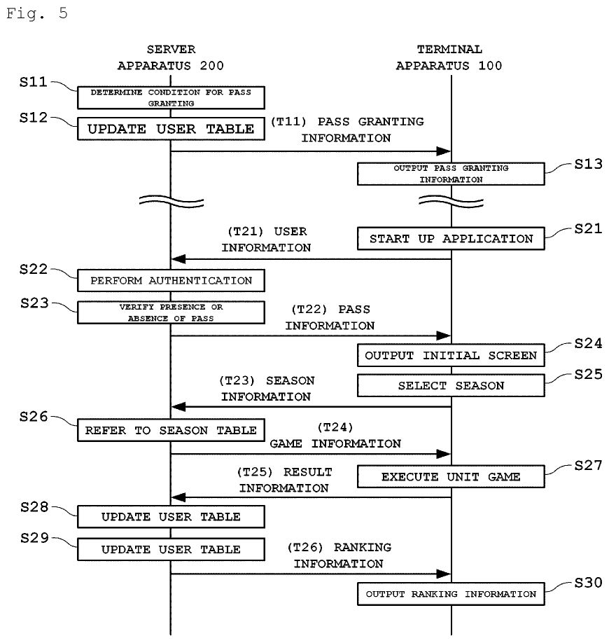

FIG. 2 is a conceptual diagram of a schematic configuration of a system 1 according to the embodiment of the present disclosure. Referring to FIG. 2, the system 1 includes a terminal apparatus 100 retained by a user and a server apparatus 200 communicably connected to the terminal apparatus 100 through a network 300. In the system 1, the server apparatus 200 and the terminal apparatus 100 each execute a program stored in a memory, resulting in execution of a game application according to the present embodiment. The server apparatus 200 and the terminal apparatus 100 have mutual communication anytime, so that transmission and reception of various types of information necessary for progress of the game application (e.g., refer to FIGS. 4A and 4B) or a program is performed.

Note that, although only one terminal apparatus 100 is provided in the example of FIG. 2, needless to say, two terminal apparatuses 100 or more can be provided in total. Although the single server apparatus 200 is provided, the constituent elements and processing in the server apparatus 200 can be divided between a plurality of server apparatuses or a plurality of cloud server apparatuses. Furthermore, although the game application according to the present embodiment is executed by the system 1 including the server apparatus 200 and the terminal apparatuses 100, the game application can be executed by only the terminal apparatuses 100 without the server apparatus 200.

### 3. Configuration of Server Apparatus 200

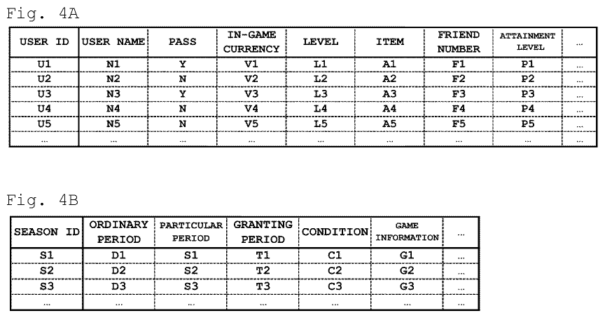

FIG. 3 is a block diagram of an exemplary configuration of the server apparatus 200 according to the embodiment of the present disclosure. The server apparatus 200 does not necessarily include all constituent elements illustrated in FIG. 3, and thus can omit part of the constituent elements. Alternatively, the server apparatus 200 can further include another constituent element.

Referring to FIG. 3B, the server apparatus 200 includes a memory 211 including a RAM, a ROM, a nonvolatile memory, and an HDD, a processor 212 achieved by a CPU, and a communication interface 213. Then, the constituent elements are mutually electrically connected through a control line and a data line.

The memory 211 including the RAM, the ROM, the nonvolatile memory, and the HDD, functions as a storage unit. The memory 211 stores, as programs, an instruction command for executing the game application according to the present embodiment and an instruction command for executing the OS. Such a program is loaded and executed by the processor 212. The memory 211 (particularly, the RAM) is temporarily used for execution of data write and data read during execution of the program by the processor 212. The memory 211 stores, in addition to a user table illustrated in FIG. 4A and a season table illustrated in FIG. 4B, information on each object arranged in a virtual game space and rendering information thereon. Furthermore, the memory 211 stores a program for performing, for example, processing of allowing execution of the first unit game regardless of determination information in a case where a first user selects execution of the first unit game in the first game period and processing of allowing execution of the second unit game on the basis of the determination information in a case where the first user selects execution of the second unit game in the first game period, through the communication interface 213.

The processor 212 achieved by the CPU (microcomputer) functions as a control unit that controls, on the basis of various types of programs stored in the memory 211, the connected other constituent elements. In the present embodiment, particularly, the processor 212 performs, for example, processing of allowing execution of the first unit game regardless of the determination information in a case where the first user selects execution of the first unit game in the first game period and processing of allowing execution of the second unit game on the basis of the determination information in a case where the first user selects execution of the second unit game in the first game period, through the communication interface 213. The processor 212 may be achieved by a single CPU or may be achieved by a plurality of CPUs.

As an example, the communication interface 213 performs processing, such as modulation and demodulation, for transmission and reception of the program for executing the game application according to the present embodiment and various types of information, with each terminal apparatus 100 through the network 300 or with another server apparatus through the network 300. The communication interface 213 communicates with each terminal apparatus or the another server apparatus, in accordance with the wireless communication scheme described above or a publicly known wired communication scheme.

### 4. Information that Memory Stores

FIG. 4A conceptually illustrates the user table stored in the server apparatus 200 according to the embodiment of the present disclosure. Information stored in the user table includes user ID information newly generated every time a user who uses the game application is newly registered, and is updated anytime in accordance with the progress of the game application.

Referring to FIG. 4A, in the use table, for example, user name information, pass information, in-game currency information, level information, item information, friend-number information, and attainment-level information are stored in association with user ID information. The “user ID information” is unique to each user and serves as information for specifying each user. The “user name information” serves as information for specifying a name that each user uses in the game application. For example, when executing the game application for the first time, each user can set the information, arbitrarily. The “pass information” indicates whether or not item information called a pass is possessed. In a case where the pass is possessed, the corresponding user is allowed to execute the unit game that is originally executable in the next game period, before the game period. The pass is granted, for example, in accordance with the condition for pass granting to be described separately or the expenditure of in-game currency usable in the virtual game. The “in-game currency information” is exemplary currency usable in the game application and indicates the amount of in-game virtual currency retained by each user. In the game application, for example, expenditure is made due to purchase of another item, pass, power of execution of a unit game before the game period in which the unit game is executable, or character, and addition is made in accordance with a result of execution of a unit game. Note that in-game currency is not limited to currency usable only in the virtual game, and thus any currency or point in the real world can be used.

The “level information” indicates the proficiency level of a user to the virtual game. The level information varies, for example, on the basis of the number of times of execution of a unit game by a user or a result of execution of a unit game. For example, the level information may be reset every time a game period terminates and the season corresponding to the game period terminates. The “item information” indicates an item acquired, for example, due to the expenditure of in-game currency or a result of execution of a unit game. Examples of such an item include an accessory, a character, a treasure box, a recovery item, an attack item, and a special skill. The “friend-number information” indicates the number of other users with which each user has a predetermined relationship. Examples of the predetermined relationship include the relationship between a followed user and a follower user and the relationship between a user and a friend user or an assistant user. As an example, one user transmits, to another user, a request for setting a predetermined relationship, and then the predetermined relationship is set if the another user approves the request. As another example, in response to transmission of a request for setting a predetermined relationship from one user to another user, the predetermined relationship is set, regardless of approval or disapproval from the another user.

The “attainment-level information” indicates the attainment level in the virtual game. Specifically, the attainment-level information corresponds to an accumulated result due to repeated execution of a unit game. Examples thereof include the numbers of wins and losses, the percentage of wins, the amount of acquired territory, the number of acquired items, and the number of beaten enemy characters. For example, the attainment-level information may be reset every time a game period terminates and the season corresponding to the game period terminates. Note that, although not particularly illustrated in FIG. 4A, various types of information, such as the stamina of each user and a character in use, may be stored in association with the corresponding user ID information.

FIG. 4B conceptually illustrates the season table stored in the server apparatus 200 according to the embodiment of the present disclosure. The information stored in the season table is updated constantly every time information regarding each season is generated.

Referring to FIG. 4B, in the season table, for example, ordinary period information, particular period information, granting period information, condition information, and game information are stored in association with season ID information. The “season ID information” is unique to each season and serves as information for specifying each season. The “ordinary period information” indicates the game period from start to termination of each season. In a game period indicated in the ordinary period information, the unit game that is usually executable in the game period can be executed, regardless of the presence or absence of the pass. The “particular period information” indicates the game period in which the unit game that is executable in the game period set to each season is allowed to be executed in a case where it is determined that the pass is possessed. Preferably, time after the previous game period starts is set as the start time of the particular period information, and the termination time of the previous game period is set as the termination time of the particular period information. The “granting period information” indicates the period in which pass granting is performed. Note that such a granting period is not necessarily provided and thus granting may be performed at any timing.

The “condition information” indicates the condition for pass granting. More specifically, indicated is the condition for allowing execution of the unit game that is executable in the game period set to each season, before the season. Examples of such a condition include the proficiency level in the virtual game, the attainment level in the virtual game, the friend number, permission of the operator of the virtual game, and any combination thereof. As the condition information, respective different conditions may be set to the seasons or the same conditions may be set to the seasons. The “game information” corresponds to various types of game information necessary for execution of the unit game in the game period set to each season. Examples of such game information include operation information input from each user to the corresponding terminal apparatus, rendering information on objects that are part of each unit game, information on characters that appear in each unit game, and information on items acquirable in each unit game.

### 5. Information to be Transmitted and Received between Terminal Apparatus 100 and Server Apparatus 200

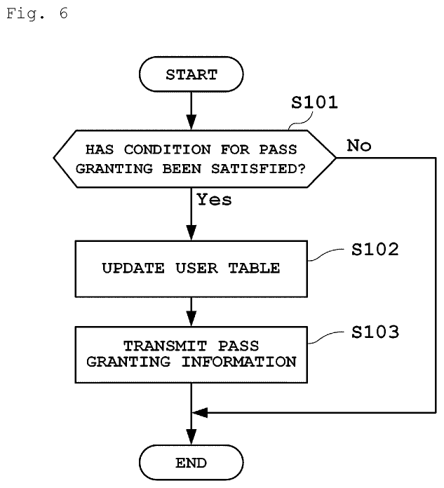

FIG. 5 illustrates a processing sequence to be performed between the terminal apparatus 100 and the server apparatus 200 according to the embodiment of the present disclosure. Specifically, the processing sequence in FIG. 5 is performed between the terminal apparatus 100 and the server apparatus 200 in a case where a pass is granted to a particular user and in a case where the user starts up the game application to execute a unit game in the terminal apparatus 100.

First, described will be the processing sequence in a case where a pass is granted to a particular user. Referring to FIG. 5, the server apparatus 200 determines whether or not the condition for pass granting has been satisfied, anytime, for example, on the basis of received game information (S11). When determining that the condition for pass granting has been satisfied, the server apparatus 200 updates the pass information from “N” (indicating that no pass is possessed) to “Y” (indicating that a pass is possessed) in the user table, and additionally stores the pass to be granted into the memory 211 (S12). The server apparatus 200 transmits pass granting information (E1) indicating that the pass has been granted, to the terminal apparatus 100 through the communication interface 213.

When receiving the pass granting information, under control of a processor, the terminal apparatus 100 outputs that the pass has been granted, through an output interface of the terminal apparatus 100 (S13). For example, a display of the terminal apparatus 100 displays that the pass has been granted. Thus, the user of the terminal apparatus 100 can be notified that the pass has been granted to the user.

Next, described will be the processing sequence in a case where the user starts up the game application to execute a unit game in the terminal apparatus 100. Referring to FIG. 5, when an input interface of the terminal apparatus 100 accepts an instruction input from the user, the game application starts up, on the basis of the instruction input, in order to execute the virtual game (S21). Then, user information (T11) including the user ID information on the user of the terminal apparatus 100 is transmitted to the server apparatus 200 through a communication interface.

The server apparatus 200 having received the user information authenticates whether or not the user is valid, on the basis of the received user ID information (S12). Then, with reference to the user table, the server apparatus 200 determines whether or not the user has the pass, on the basis of the user ID information included in the user information (S23). In a case where the user has the pass, the server apparatus 200 transmits, to the terminal apparatus 100 through the communication interface 213, pass information (T22) indicating that the unit game in the season following the current season is allowed to be executed ahead. On the other hand, in a case where the user has no pass, the server apparatus 200 transmits, to the terminal apparatus 100 through the communication interface 213, pass information indicating that the unit game is not allowed to be executed ahead.

The terminal apparatus 100 having received the pass information outputs an initial screen through the output interface, on the basis of the pass information (S24). In a case where the unit game is allowed to be executed ahead, the terminal apparatus 100 displays, on the initial screen, an icon for selection of the season corresponding to the current game period and an icon for selection of the season corresponding to the next game period. Then, the terminal apparatus 100 accepts an instruction input from the user through the input interface, and selects the season to be performed, on the basis of the instruction input (S25). On the other hand, in a case where the unit game is not allowed to be executed ahead, only the icon for selection of the season corresponding to the current game period is displayed. Then, the terminal apparatus 100 accepts an instruction input from the user through the input interface, and selects the season to be performed, on the basis of the instruction input.

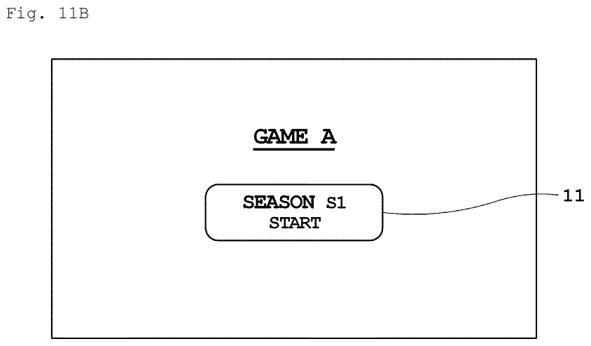

Here, FIGS. 11A and 11B each illustrate an exemplary image output on the terminal apparatus 100 according to the embodiment of the present disclosure. Specifically, FIG. 11A illustrates an exemplary initial screen in a case where the unit game in the season following the current season is allowed to be executed ahead because the user retaining the terminal apparatus 100 has the pass. Referring to FIG. 11A, the initial screen includes, together with a game title, an icon 11 for selection of the season corresponding to the current game period and an icon 12 for selection of the season corresponding to the next game period. That is, the user carries out an instruction input for selecting the icon 12 through the input interface, so that the unit game in the season S2 can be executed ahead even during the game period corresponding to the season S1.

FIG. 11B illustrates an exemplary initial screen in a case where the unit game in the season following the current season is not allowed to be executed ahead because the user retaining the terminal apparatus 100 has no pass. Referring to FIG. 11B, the initial screen includes, together with the game title, only the icon 11 for selection of the season corresponding to the current game period. That is, the user carries out an instruction input for selecting the icon 11 through the input interface, so that only the unit game in the season S1 can be executed, namely, the unit game in the season S2 is not allowed to be executed ahead.

Referring back to FIG. 5, on the basis of the selection in S25, the terminal apparatus 100 transmits, to the server apparatus 200 through the communication interface, season information (T23) including the season ID information on the selected season. The server apparatus 200 having received the season information refers to the season table (S26), and transmits game information (T24) necessary for execution of the virtual game, on the basis of the received season ID information. The terminal apparatus 100 having received the game information displays a game execution screen through the output interface. Then, the terminal apparatus 100 executes the unit game selected on the basis of an instruction input from the user accepted through the input interface (S27). When the unit game terminates, the terminal apparatus 100 transmits, to the server apparatus 200 through the communication interface, result information (T25) including a result of execution of the unit game.

The server apparatus 200 having received the result information updates and stores the user table, on the basis of the received result of execution (S28). Then, the server apparatus 200 generates rankings, for example, on the basis of the updated attainment-level information (S29), and transmits the rankings as ranking information (T26) to the terminal apparatus 100 through the communication interface 213. The terminal apparatus 100 having received the ranking information outputs the received ranking information through the output interface (S30).

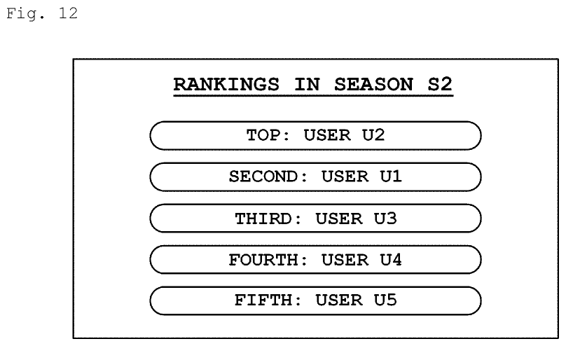

Here, FIG. 12 illustrates an exemplary image output on the terminal apparatus 100 according to the embodiment of the disclosure. Specifically, FIG. 12 illustrates an exemplary ranking screen output due to execution of the unit game by the user in the season S2 corresponding to the second game period. Referring to FIG. 12, together with a display indicating the rankings in the season S2, provided is a list of user ID information that is ranked, for example, in attainment level and is in order from the top in ranking. Note that ranking in the rankings will be described in detail below.

### 6. Processing Flow to be Performed in Server Apparatus 200

(1) Processing according to Pass Granting

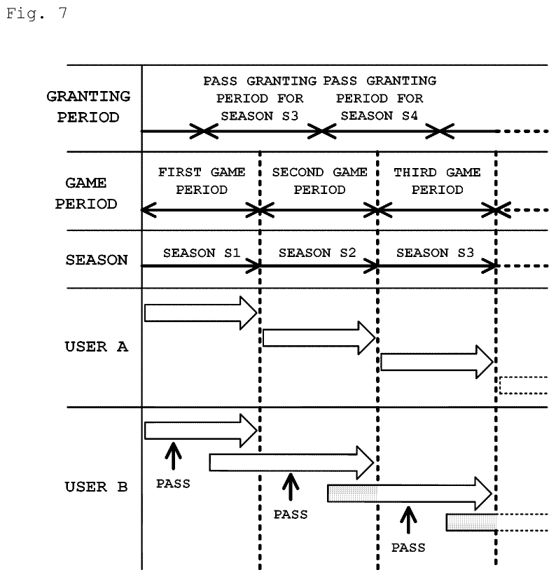

FIG. 6 illustrates a processing flow to be performed in the server apparatus 200 according to the embodiment of the present disclosure. Specifically, the processing flow in FIG. 6 is performed in predetermined cycles for pass granting in S11 and S12 of FIG. 5. The processing flow is performed mainly when the processor 212 in the server apparatus 200 reads and executes a program stored in the memory 211.

Referring to FIG. 6, with reference to the user table and the season table, the processor 212 determines whether or not a user having satisfied the condition for pass granting is present (S101). Specifically, the processor 212 first refers to the granting period information in the season table and extracts the season ID information corresponding to the pass granting period. Then, in a case where the season ID information corresponding to the granting period is found, the processor 212 extracts the condition information associated with the season ID information. With reference to the extracted condition information and the user table, the processor 212 determines whether or not a user having satisfied the condition is present. For example, in a case where the condition corresponds to the proficiency level in the virtual game, with reference to the level information, the processor 212 extracts a user having a proficiency level exceeding the proficiency level set as the condition. In a case where the condition corresponds to the attainment level in the virtual game (e.g., the number of wins), with reference to the attainment-level information, the processor 212 extracts a user having an attainment level exceeding the attainment level set as the condition. In a case where the condition corresponds to the friend number, with reference to the friend-number information, the processor 212 extracts a user having friends exceeding the friend number set as the condition. In a case where the condition corresponds to acquisition of particular item information in a unit game different from the unit game executable due to the pass, with reference to the item information, the processor 212 extracts a user to which the particular item information is stored. In a case where the condition corresponds to permission of the operator of the virtual game, the processor 212 extracts a user permitted by the operator. Note that, although a user having a level exceeding the threshold set as the condition in any of the examples is determined as satisfying the condition, a user having a level less than the threshold may be determined as satisfying the condition, instead.

Next, in a case where a user having satisfied the condition for pass granting is present, with reference to the user table, the processor 212 updates the pass information associated with the user ID information on the user, from “N” to “Y” and stores the user table (S102). Then, the processor 212 transmits pass granting information including that the pass has been granted, to the terminal apparatus 100 retained by the user, through the communication interface 213 (S103). Then, the processing according to pass granting terminates.

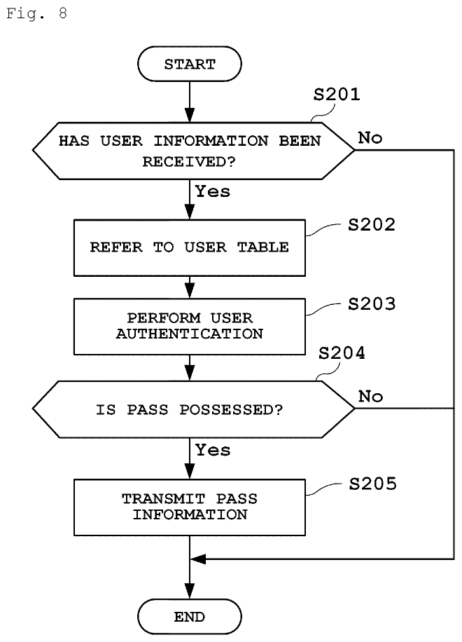

Here, FIG. 7 conceptually illustrates progress of the virtual game according to the embodiment of the present disclosure. Specifically, FIG. 7 explanatorily illustrates the relationship between a pass and each game period. Referring to FIG. 7, the user A can execute the first unit game a plurality of times in the season S1 set to the first game period. When the next second game period starts following termination of the first game period, the user A can execute a second unit game a plurality of times in the season S2 set to the second game period. Furthermore, when the next third game period starts following termination of the second game period, the user A can execute a third unit game a plurality of times in the season S3 set to the third game period. That is, the user A can execute the first unit game only in the first game period, the second unit game only in the second game period, and the third unit game only in the third game period, and thus is not allowed to execute the second unit game and the third unit game in the first game period and the third unit game in the second game period.

On the other hand, the user B having satisfied the condition for pass granting in the pass granting period for the season S2 before the second game period is granted the pass. The user B having satisfied the condition for pass granting in the pass granting period for the season S3 before the third game period is granted the pass. Thus, the user B can execute the second unit game executable in the second game period, in the particular period before the second game period corresponding to the season S2. The user B can execute the third unit game executable in the third game period, in the particular period before the third game period corresponding to the season S3.

(2) Processing according to Determination of Presence or Absence of Pass

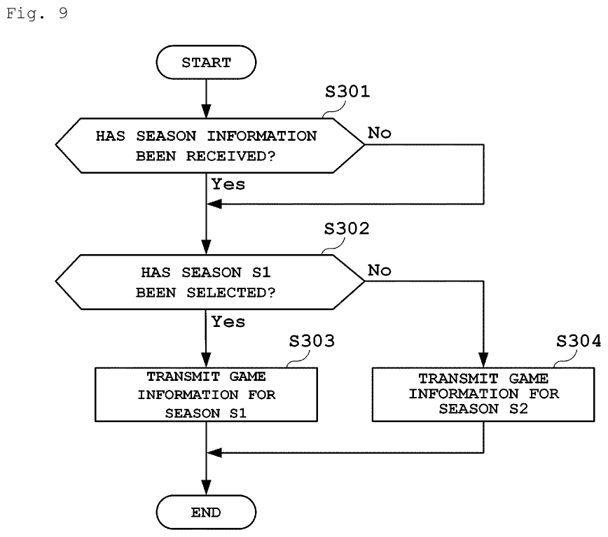

FIG. 8 illustrates a processing flow to be performed in the server apparatus 200 according to the embodiment of the present disclosure. Specifically, the processing flow in FIG. 8 is performed in determination of the presence or absence of the pass in S22 and S23 of FIG. 5. The processing flow is performed mainly when the processor 212 in the server apparatus 200 reads and executes a program stored in the memory 211. Note that, in the following, for convenience of description, given will be a case where the pass for the season S2 is granted in the first game period and the second unit game can be executed before the second game period.

Referring to FIG. 8, the processor 212 determines whether or not an interrupt signal has been received due to reception of the user information including the user ID information, from the terminal apparatus 100 through the communication interface 213 (S201). Then, in a case where the interrupt signal has been received, the processor 212 refers to the user table (S202), and authenticates whether or not the user is valid, with reference to the user table and the season table, on the basis of the received user ID information (S203). In a case where the user is valid as a result of the authentication, the processor 212 determines which the pass indicates, “Y” or “N”, on the basis of the pass information and the user ID information in the user table (S204). Then, in a case where the pass indicates “Y”, the processor 212 allows execution of:

the first unit game executable in the first game period, regardless of the presence or absence of the pass; and

the second unit game executable in the first game period only in a case where the pass is possessed. Next, the processor 212 transmits, to the terminal apparatus 100 through the communication interface 213, pass information indicating that both of the first unit game and the second unit game executable in the second game period set following the first game period are allowed to be executed in the first game period (S204).

On the other hand, in a case where the pass indicates “N”, the processor 212 allows execution of only:

the first unit game executable in the first game period, regardless of the presence or absence of the pass. Next, the processor 212 transmits, to the terminal apparatus 100 through the communication interface 213, pass information indicating that only the first unit game is allowed to be executed and thus the second unit game executable in the second game period set following the first game period is not allowed to be executed. Then, the processing according to determination of the presence or absence of the pass terminates.

(3) Processing according to Season Selection

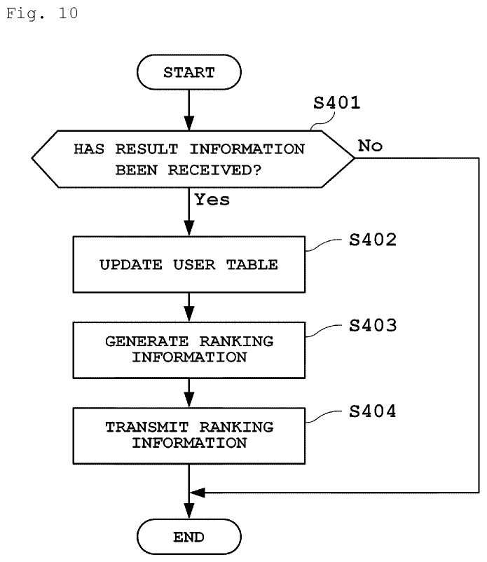

FIG. 9 illustrates a processing flow to be performed in the server apparatus 200 according to the embodiment of the present disclosure. Specifically, the processing flow in FIG. 9 is performed in S26 of FIG. 5. The processing flow is performed mainly when the processor 212 in the server apparatus 200 reads and executes a program stored in the memory 211. Note that, in the following, for convenience of description, given will be a case where the pass for the season S2 is granted in the first game period and the second unit game can be executed before the second game period.

Referring to FIG. 9, the processor 212 determines whether or not an interrupt signal has been received due to reception of the season information including the season ID information selected by the user, from the terminal apparatus 100 through the communication interface 213 (S301). Then, in a case where the interrupt signal has been received, the processor 212 determines whether or not the season S1 set to the first game period has been selected, on the basis of the season ID information (S302). In a case where it is determined that the season S1 has been selected, with reference to the season table, the processor 212 transmits the game information associated with the season ID information, to the terminal apparatus through the communication interface 213 (S303).

On the other hand, in a case where it is determined that the season S2 has been selected instead of the season S1, with reference to the season table, the processor 212 transmits the game information associated with the season ID information, to the terminal apparatus through the communication interface 213 (S304). Then, the processing according to season selection terminates.

(4) Processing according to Ranking Generation

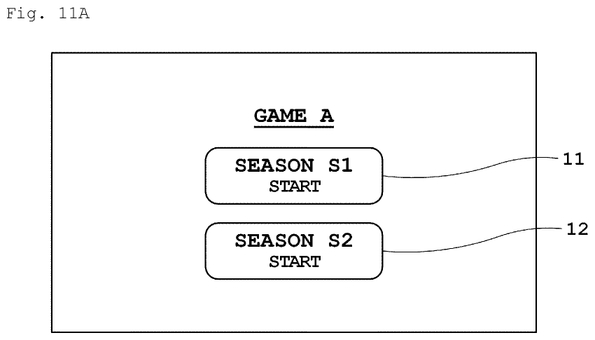

FIG. 10 illustrates a processing flow to be performed in the server apparatus 200 according to the embodiment of the present disclosure. Specifically, the processing flow in FIG. 10 is involved in ranking generation in S29 of FIG. 5. The processing flow is performed mainly when the processor 212 in the server apparatus 200 reads and executes a program stored in the memory 211. Note that, in the following, for convenience of description, given will be a case where the second unit game is executed in the second game period.

Referring to FIG. 10, the processor 212 determines whether or not an interrupt signal has been received due to reception of the result information including a result of execution of the second unit game, from the terminal apparatus 100 through the communication interface 213 (S401). In a case where the interrupt signal has been received, the processor 212 updates the user table, on the basis of the received result information (S402). Specifically, in a case where the condition for a rise in the proficiency level in the virtual game is satisfied due to execution of the second unit game, the processor 212 updates the level information. In a case where an item is acquired due to execution of the second unit game, the processor 212 updates the item information. In a case where the condition for a rise in the attainment level is satisfied due to execution of the second unit game, the processor 212 updates the attainment-level information. In a case where in-game currency is acquired due to execution of the second unit game, the processor 212 updates the in-game currency information. Note that, although the numerical value increases in any of the examples, the numerical value may decrease instead.

Next, the processor 212 generates ranking information, on the basis of the information stored in the updated user table (S403). Specifically, a result of execution of the second unit game by a user and a result of execution of the second unit game by a different user from the user are each reflected in the user table, resulting in generation of rankings between a plurality of users including the user and the different user. Examples of the ranking information include the rankings of users high in attainment level, the rankings of users high in proficiency level, and the rankings of users having a large number of particular items.

Here, like the user B of FIG. 7, a user having the pass for the season S2 can execute the second unit game in the first game period ahead of other users. When the first game period terminates, the processor 212 may reset, for example, the level information or proficiency-level information in which a result of execution of the second unit game is reflected. Alternatively, the processor 212 may store the level information or proficiency-level information updated in the first game period, separately from the level information or proficiency-level information updated in the second game period. Then, the processor 212 generates rankings with only the level information or proficiency-level information updated in the second game period, without the level information or proficiency-level information updated in the first game period. This arrangement enables a user having the pass and a user having no pass, to compete for ranking, from the same starting line. Meanwhile, a user having the pass can practice the second unit game in advance in the first game period, so that the user can have a benefit in which a rise can be made in advance in the level of skill in the second unit game.

The processor 212 may add the level information or proficiency-level information updated on the basis of a result of execution of the second unit game in the first game period, directly to the level information or proficiency-level information updated in the second game period. This arrangement enables acquisition of a more direct benefit in which a user having the pass starts the second unit game ahead of other users to improve, in advance, each numerical value related to ranking generation.

The processor 212 transmits such generated ranking information as above, to the terminal apparatus 100 through the communication interface 213 (S404). Then, the processing according to season selection terminates.

### 7. Other Examples

### (1) Exemplary Processing in Terminal Apparatus

Other examples applicable to the system 1 described with FIGS. 1 to 12 will be given below. Note that, unless otherwise noted, the examples are similar in configuration, processing, and procedure to the examples described with FIGS. 1 to 12. The examples described with FIGS. 1 to 12 and the following examples can be appropriately combined for use.

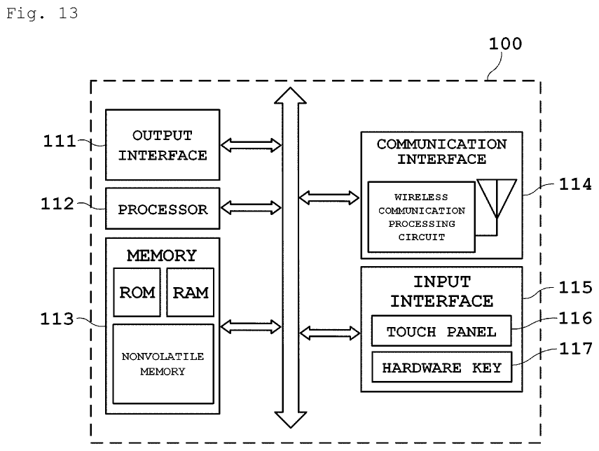

In the examples of FIGS. 5 and 8, given has been the case where the server apparatus 200 illustrated in FIG. 3 determines whether or not to allow the second unit game executable in the second game period, to be executed in the first game period. However, for example, such a terminal apparatus 100 as illustrated in FIG. 13 can perform similar determination.

FIG. 13 is a block diagram of an exemplary configuration of the terminal apparatus 100 according to the embodiment of the present disclosure. The terminal apparatus 100 does not necessarily include all constituent elements illustrated in FIG. 13 and thus can omit part of the constituent elements. Alternatively, the terminal apparatus 100 can further include another constituent element. An example of the terminal apparatus 100 is a stationary game console. In addition, suitably provided can be any apparatus capable of executing the game application according to the present disclosure, such as a portable terminal apparatus that is typified by a smartphone and is capable of wireless communication, a portable game console, a feature phone, a portable information terminal, a personal digital assistant (PDA), a laptop personal computer, and a desktop personal computer.

Referring to FIG. 13, the terminal apparatus 100 includes an output interface 111, a processor 112, a memory 113 including a RAM, a ROM, and a nonvolatile memory (if necessary, an HDD), a communication interface 114 including a communication processing circuit and an antenna, and an input interface 115 including a touch panel 116 and a hardware key 117. Then, the constituent elements are mutually electrically connected through a control line and a data line.

The processor 112 achieved by a central processing unit (CPU) (microcomputer) functions as a control unit that controls, on the basis of various types of programs stored in the memory 113, the connected other constituent elements. Specifically, the processor 112 reads, from the memory 113, a program for executing the game application according to the virtual game or a program for executing an operating system (OS), and executes the program. The processor 112 performs, for example, processing of allowing execution of the first unit game regardless of determination information in a case where the first user selects execution of the first unit game in the first game period and processing of allowing execution of the second unit game on the basis of the determination information in a case where the first user selects execution of the second unit game in the first game period. Note that the processor 112 may be achieved by a single CPU or may be achieved by a plurality of CPUs. For the processor 112, a different type of processor, such as a graphics processing unit (GPU) tailored for image processing, may be appropriately combined.

The memory 113 including the ROM, the RAM, the nonvolatile memory, and the HDD, functions as a storage unit. The ROM stores, as programs, an instruction command for executing the game application according to the present embodiment and an instruction command for executing the OS. The RAM serves as a memory for use in data write and data read while the processor 112 is processing a program stored in the ROM. The nonvolatile memory serves as a memory to which data write and data read are performed due to execution of the program, and the written data remains saved even after the execution of the program terminates. The memory 113 stores game information necessary for execution of the game application (e.g., each piece of information associated with the user ID information on the user retaining the terminal apparatus 100 in the information stored in the user table of FIG. 4A and each piece of information in the season table of FIG. 4B). The memory 113 stores a program for, for example, processing of allowing execution of the first unit game regardless of determination information in a case where the first user selects execution of the first unit game in the first game period and processing of allowing execution of the second unit game on the basis of the determination information in a case where the first user selects execution of the second unit game in the first game period. Note that, although not particularly illustrated as the memory 113, for example, a removable storage medium or a database may be connected through the input interface 115.

The communication interface 114 functions as a communication unit that performs, through the communication processing circuit and the antenna, transmission and reception of information with the server apparatus 200 or another terminal apparatus installed distantly. The communication processing circuit performs processing of receiving, from the server apparatus 200, the program for executing the game application according to the present embodiment or various types of information for use in the game application (e.g., game information, pass information, and pass granting information), in accordance with the progress of the game application. The communication processing circuit performs processing of transmitting, to the server apparatus 200, information on a result of processing due to execution of the game application (e.g., result information and user information).

The communication processing circuit is based on a wide-band wireless communication scheme typified by a long-term evolution (LTE) scheme in terms of processing, but can be based on a narrow-band wireless communication scheme, such as a wireless local area network (LAN) typified by IEEE 802.11 or Bluetooth (registered trademark), in terms of processing. Instead of wireless communication or in addition to wireless communication, wired communication can be used.

The input interface 115 including the touch panel 116 and/or the hardware key 117 functions as an input unit that accepts an instruction input from the user according to execution of the game application. The touch panel 116 is arranged covering a display as the output interface 111 and outputs, to the processor 112, information on the arrangement coordinates corresponding to image data that the display displays. As a touch panel technique, a publicly known technique is available, such as a resistive membrane technique, a capacitive coupling technique, or a surface acoustic wave technique with ultrasonic waves. Note that, because the touch panel 116 is an exemplary input interface, needless to say, a different input interface can be used instead. The communication interface 114 that connects with a controller or a keyboard connectable to the terminal apparatus 100 by wireless or by wire can function as the input interface 115 that accepts an instruction input from the user through the controller or the keyboard.

The output interface 111 functions as an output unit that reads, in accordance with an instruction from the processor 112, image information stored in the memory 113 and outputs various types of displays generated due to execution of the game application according to the present embodiment (e.g., refer to FIGS. 10, 11A, and 12B). Examples of the output interface 111 include a liquid crystal display and an organic electroluminescent (EL) display. However, the terminal apparatus 100 itself is not necessarily equipped with a display. For example, the communication interface 114 that connects with a display connectable to the terminal apparatus 100 by wireless or by wire can function as the output interface 111 that outputs display data to the display.

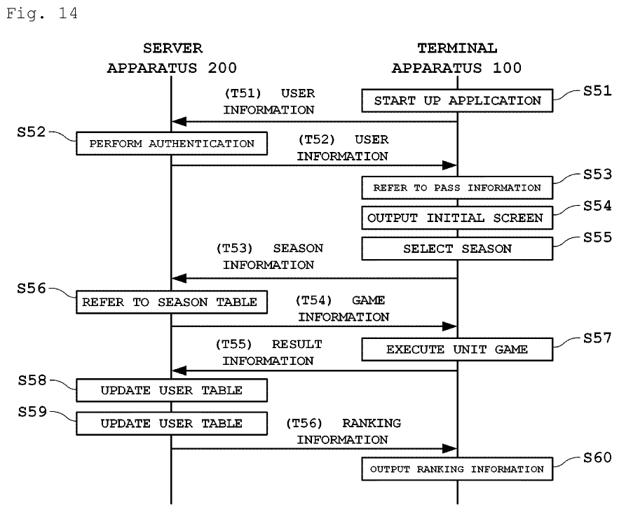

FIG. 14 illustrates a processing sequence to be performed between the terminal apparatus 100 and the server apparatus 200 according to the embodiment of the present disclosure. Specifically, the terminal apparatus 100 illustrated in FIG. 13 is used in the processing sequence in FIG. 14. Referring to FIG. 14, when the input interface 115 accepts an instruction input from the user, the processor 112 in the terminal apparatus 100 starts up the game application, on the basis of the instruction input, in order to execute the virtual game (S51). Then, the processor 112 transmits, to the server apparatus 200 through the communication interface 114, user information (T51) including the user ID information on the user of the terminal apparatus 100.

The server apparatus 200 having received the user information authenticates whether or not the user is valid, on the basis of the received user ID information (S52). Then, in a case where it is determined that the user is valid as a result of the authentication, the server apparatus 200 transmits, to the terminal apparatus 100, game information (154) for execution of the unit game in the currently executable season and execution of the unit game in the following season.

In response to reception of the game information through the communication interface 114, the processor 112 in the terminal apparatus 100 refers to the pass information stored in the memory 113 (S53). Then, in a case where “Y” is stored as the pass information, the processor 112 allows the unit game (second unit game) executable in the next game period (second game period) set following the current game period (first game period), to be executed in the current game period (first game period). In this case, the processor 112 allows the unit game (first unit game) that is originally executable in the current game period (first game period), to be executed regardless of whether or not “Y” is stored as the pass information. On the other hand, in a case where “N” is stored as the pass information, the processor 112 does not allow the unit game (second unit game) executable in the next game period (second game period) set following the current game period (first game period), to be executed in the current game period (first game period). However, in this case, the processor 112 allows the unit game (first unit game) that is originally executable in the current game period (first game period), to be executed regardless of whether or not “Y” is stored as the pass information.

Then, the processor 112 outputs an initial screen through the output interface 111, on the basis of a result of reference to the pass information (S54). Specifically, the processor 112 outputs the initial screen exemplified in FIG. 11A in a case where “Y” is stored as the pass information and outputs the screen exemplified in FIG. 11B in a case where “N” is stored as the pass information. Note that the following processing is similar to the processing according to S25 to S30 illustrated in FIG. 5.

### (2) Exemplary Events

Referring to FIGS. 1 to 12, given has been the case where the range from beginning to end of each game period corresponds to one season and the second game period starts immediately after the first game period terminates, as illustrated in FIG. 7. However, the game periods are not necessarily consecutive.

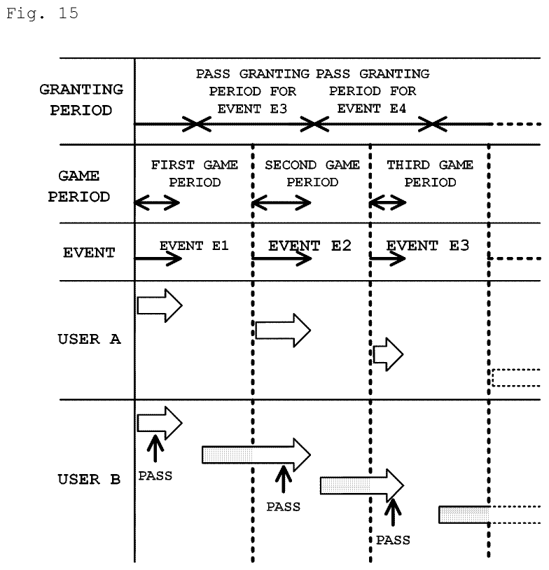

FIG. 15 conceptually illustrates progress of the virtual game according to the embodiment of the present disclosure. Referring to FIG. 15, the second game period starts after a certain period following termination of the first game period, and furthermore the third game period starts after a certain period following termination of the second game period. Events E1 to E3 that each enable execution of at least one unit game, take place one-to-one in the game periods.

The user A can execute the first unit game a plurality of times in the event E1 set to the first game period. When the next second game period starts after the first game period terminates, the user A can execute the second unit game a plurality of times in the event E2 set to the second game period. Furthermore, when the next third game period starts after the second game period terminates, the user A can execute the third unit game a plurality of times in the event E3 set to the third game period. That is, the user A can execute the first unit game only in the first game period, the second unit game only in the second game period, and the third unit game only in the third game period, and thus is not allowed to execute the second unit game and the third unit game in the first game period and the third unit game in the second game period.

On the other hand, the user B having satisfied the condition for pass granting in the pass granting period for the event E2 before the second game period is granted the pass. The user B having satisfied the condition for pass granting in the pass granting period for the event E3 before the third game period is granted the pass. Thus, the user B can execute the second unit game executable in the second game period, in the particular period before the second game period corresponding to the event E2. The user B can execute the third unit game executable in the third game period, in the particular period before the third game period corresponding to the event E3.

As above, according to the present embodiment, provided can be a processing apparatus, a program, and a method that enable provision of a more interesting season-based virtual game to a user.

Any processing and the corresponding procedure thereto in the present specification are not limited to the explicit manner in the embodiment and thus can be achieved by software, hardware, or a combination thereof. Specifically, any processing and the corresponding procedure thereto in the present specification are achieved by implementation of logic corresponding to the processing into a medium, such as an integrated circuit, a volatile memory, a nonvolatile memory, a magnetic disk, or an optical storage. Any processing and the corresponding procedure thereto in the present specification can be performed by various types of computers including a terminal apparatus and a server apparatus, with the processing/procedure implemented as a computer program.

Even in a case where any processing and the corresponding procedure thereto in the present specification are performed by a single apparatus, a single piece of software, a single component, or a single module, such processing or the corresponding procedure thereto can be performed by a plurality of apparatuses, a plurality of pieces of software, a plurality of components, and/or a plurality of modules. Even in a case where any type of information in the present specification is stored in a single memory or a single storage unit, such a type of information can be stored, in a distribution manner, in a plurality of memories in a single apparatus or in a plurality of memories arranged, in a distribution manner, in a plurality of apparatuses. Furthermore, the elements of software and hardware in the present specification can be integrated into a smaller number of constituent elements or can be divided into a larger number of constituent elements, for achievement.

The processing apparatus, program, and method being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

What is claimed is:

1. A processing apparatus comprising:
a memory configured to store computer readable instructions and determination information for determination of whether or not a first user who causes progress of a virtual game is allowed to execute the virtual game, the virtual game including at least a first game period in which a first unit game is executable and a second game period in which a second unit game is executable, the second game period being set following the first game period; and
a processor configured to execute the computer readable instructions so as to:
allow, in a case where the first user selects execution of the first unit game in the first game period, the execution of the first unit game regardless of the determination information; and
determine, in a case where the first user selects execution of the second unit game in a period before the second game period, whether the execution of the second unit game is allowed based on the determination information.

2. The processing apparatus according to claim 1,
wherein the determination information indicates whether or not the execution of the second unit game is allowable in the period before the second game period.

3. The processing apparatus according to claim 1,
wherein the determination information serves as item information for determination of whether or not the execution of the second unit game is allowable in the period before the second game period.

4. The processing apparatus according to claim 3,
wherein the item information is granted due to expenditure of in-game currency usable in the virtual game.

5. The processing apparatus according to claim 3,
wherein the item information is granted based on a result acquired due to execution of a unit game different from the second unit game in the virtual game.

6. The processing apparatus according to claim 5,
wherein the result corresponds to at least either information indicating a proficiency level of the first user in the virtual game or information indicating an attainment level in the virtual game.

7. The processing apparatus according to claim 3,
wherein the item information is acquirable during execution of a unit game different from the second unit game in the virtual game.

8. The processing apparatus according to claim 1,
wherein the first user is enabled to set a predetermined relationship with at least one user different from the first user, and
the determination information indicates a number of users, different from the first user, to which the predetermined relationship with the first user is set.

9. The processing apparatus according to claim 1,
wherein the virtual game is executable by a second user different from the first user, and
the processor is further configured to generate ranking based on a first result of the second unit game executed by the first user and a second result of the second unit game executed by the second user.

10. The processing apparatus according to claim 9,
wherein the first result includes a result of the second unit game executed in the period before the second game period.

11. The processing apparatus according to claim 9,
wherein the first result does not include a result of the second unit game executed in the period before the second game period.

12. A computer program product embodying computer readable instructions stored on a non-transitory computer-readable storage medium for causing a computer to execute a process by a processor, the computer including a memory configured to store determination information for determination of whether or not a first user who causes progress of a virtual game is allowed to execute the virtual game, the virtual game including at least a first game period in which a first unit game is executable and a second game period in which a second unit game is executable, the second game period being set following the first game period, the computer being configured to perform the steps of:
allowing, in a case where the first user selects execution of the first unit game in the first game period, the execution of the first unit game regardless of the determination information; and
determining, in a case where the first user selects execution of the second unit game in a period before the second game period, whether the execution of the second unit game is allowed based on the determination information.

13. The computer program product according to claim 12,
wherein the determination information serves as item information for determination of whether or not the execution of the second unit game is allowable in the period before the second game period.

14. The computer program product according to claim 13,
wherein the item information is granted based on a result acquired due to execution of a unit game different from the second unit game in the virtual game.

15. The computer program product according to claim 14,
wherein the result corresponds to at least either information indicating a proficiency level of the first user in the virtual game or information indicating an attainment level in the virtual game.

16. The computer program product according to claim 12,
wherein the first user is enabled to set a predetermined relationship with at least one user different from the first user, and
the determination information indicates a number of users, different from the first user, to which the predetermined relationship with the first user is set.

17. A method for causing a processor in a computer to execute a process, the computer including a memory configured to store computer readable instructions and determination information for determination of whether or not a first user who causes progress of a virtual game is allowed to execute the virtual game, the virtual game including at least a first game period in which a first unit game is executable and a second game period in which a second unit game is executable, the second game period being set following the first game period,
the method comprising executing the computer readable instructions on the processor the steps of:
allowing, in a case where the first user selects execution of the first unit game in the first game period, the execution of the first unit game regardless of the determination information; and
determining, in a case where the first user selects execution of the second unit game in a period before the second game period, whether the execution of the second unit game is allowed based on the determination information.

18. The method according to claim 17,
wherein the determination information serves as item information for determination of whether or not the execution of the second unit game is allowable in the period before the second game period.

19. The method according to claim 18,
wherein the item information is granted based on a result acquired due to execution of a unit game different from the second unit game in the virtual game.

20. The method according to claim 19,
wherein the result corresponds to at least either information indicating a proficiency level of the first user in the virtual game or information indicating an attainment level in the virtual game.
